(19) United States
(12) Patent Application Publication
(10) Pub. No.: US 2007/0295935 A1
(43) Pub. Date: Dec. 27, 2007

(54) Separators for Alkali Metal Doped Fullerenes, Method for Separating Alkali Metals and Compounds Thereof from Fullerenes, Processes for Purification and Production of Alkali Metal Doped Fullerenes, and System Therefor

(76) Inventors: Yasuhiko Kasama, Miyagi (JP); Kenji Omote, Miyagi (JP); Yoshinori Sibata, Sendai-shi (JP); Fuyuko Yamashita, Miyagi (JP)

Correspondence Address: YOUNG & THOMPSON, 745 SOUTH 23RD STREET, 2ND FLOOR, ARLINGTON, VA, 22202, US

(21) Appl. No.: 11/667,060

(22) PCT Filed: Nov. 15, 2005
(86) PCT No.: PCT/JP05/20962

§ 371 Date: May 15, 2007

(30) Foreign Application Priority Data
Nov. 15, 2004 (JP) 2004-330118
Mar. 16, 2005 (JP) 2005-074418

(51) Int. Cl. C01B 31/02

(52) U.S. Cl. 252/182.32; 977/734

(57) ABSTRACT

Provided are a process for removing an alkali metal from a sooty residue by a easy and safe method and a process for production and purification in high purity by preliminarily enhancing the content rate of alkali metal doped fullerenes utilizing a certain organic solvent as the separator. The alkali metal that doesn't react with fullerenes and compounds thereof are removed by immersing the sooty residue prepared by the plasma method or the arc discharge method in aqueous solvent and stirring it (S100), and are collected as residue. The residue is immersed in a separator, for example, toluene (S101) and stirring is carried out (S102). Then, centrifugal separation and the like are carried out to separate the solution and the residue (S103). The content rate of the alkali metal doped fullerenes in the residue are preliminarily enhanced by repeatedly carrying out the steps S101 to S103 for the residue. The alkali metal doped fullerenes can be purified in high purity and produced without complicated operations by applying liquid chromatography to the residue in which the content rate of the alkali metal doped fullerenes is enhanced (S107).

### TECHNICAL FIELD

The present invention relates to separators for alkali metal doped fullerenes, a method for removing alkali metal and compounds thereof from fullerenes, processes for purification and production of alkali metal doped fullerenes, and system therefor.

### BACKGROUND ART

Patent document 1: Japanese Unexamined Patent Publication No. 2000-159514

Alkali metal doped fullerenes are produced using fullerenes and alkali metal as raw materials, for example, according to an arc discharge method described in the patent document 1 and a plasma method described in the present specification. At this time, there is obtained sooty residue containing unreacted fullerenes, alkali metal, the decomposed product of fullerenes and reaction products with the alkali metal in addition to the alkali metal doped fullerenes.

### DISCLOSURE OF THE INVENTION

### Problems to be Solved by the Invention

However, at present, there is no means capable of purifying alkali metal doped fullerenes from the sooty residue in high purity. In particular, the alkali metal doped fullerenes are expected in uses such as electronic material, in which high purity is required, extremely high purity is required considering the use. Therefore, it is the purpose of the invention to provide purification means capable of obtaining alkali metal doped fullerenes with high purity.

### Means for Solving Problems

The invention (1) is separators for separating alkali metal doped fullerenes from non-doped fullerenes, characterized in being selected from organic solvent in which the solubility of non-doped fullerenes is higher than that of the alkali metal doped fullerenes.

The invention (2) is the separators of the invention (1) wherein the organic solvent is toluene, a mixed solution of toluene and hexane, xylene, anisole, ethylbenzene, trimethylbenzene or cyclohexane.

The invention (3) is the separators of the invention (1) wherein the organic solvent is halobenzene, halonaphthalene or a mixed solution containing halobenzene or halonaphthalene.

The invention (4) is a method for removing alkali metal and compounds thereof from the fullerenes comprising a step of treating with aqueous solvent.

The invention (5) is the removing method of the invention (4) wherein the step is carried out in inactive atmosphere.

The invention (6) is a purification process for alkali metal doped fullerenes comprising a step of treating material containing alkali metal doped fullerenes and non-doped fullerenes by aqueous solvent.

The invention (7) is a purification process for alkali metal doped fullerenes, characterized in comprising a step of treating material containing alkali metal doped fullerenes and non-doped fullerenes by a separator selected from organic solvent in which the solubility of non-doped fullerenes is higher than that of the alkali metal doped fullerenes.

The invention (8) is the purification process of the invention (7) wherein the organic solvent is toluene, a mixed solution of toluene and hexane, xylene, anisole, ethylbenzene, trimethylbenzene or cyclohexane.

The invention (9) is the purification process of the invention (7) wherein the organic solvent is halobenzene, halonaphthalene or a mixed solution containing halobenzene or halonaphthalene.

The invention (10) is the purification process according to any one of the inventions (7) to (9) wherein the step of treatment by the separator is repeatedly carried out.

The invention (11) is the purification process according to any one of the inventions (7) to (10), comprising a step of treating by paraffin hydrocarbon or cycloparaffin hydrocarbon.

The invention (12) is the purification process of the invention (11) wherein the step of treatment by the separators and the step of treatment by paraffin hydrocarbon or cycloparaffin hydrocarbon are repeatedly carried out.

The invention (13) is the purification process according to any one of the inventions (7) to (12) wherein the step of treatment by aqueous solvent is carried out in combination.

The invention (14) is the purification process according to the inventions (13) wherein the step of treatment by the separators is carried out after the step of treatment by the aqueous solvent.

The invention (15) is the purification process according to the inventions (13) wherein after the step of treatment by the aqueous solvent, the step of treatment by paraffin hydrocarbon or cycloparaffin hydrocarbon is carried out and then, the step of treatment by the separators is carried out.

The invention (16) is the purification process according to any one of the inventions (7) to (15) wherein residue and/or solution obtained in the step of treatment by the separators or the step of treatment by paraffin hydrocarbon or cycloparaffin hydrocarbon are further provided for purification process by liquid chromatography.

The invention (17) is the purification process according to any one of the inventions (6) to (16) wherein the respective steps and some processes including movement between the respective steps are carried out in inactive atmosphere.

The invention (18) is the purification process according to any one of the inventions (6) to (16) wherein material comprising the alkali metal doped fullerenes and non-doped fullerenes is sooty residue prepared based on a plasma process or an arc discharge process.

The invention (19) is a production process for alkali metal doped fullerenes characterized in having a step of preparing sooty residue based on a plasma process or an arc discharge process, using alkali metal and fullerenes as raw materials, and a step of purifying the sooty residue by the purification process according to the invention (18).

The invention (20) is alkali metal doped fullerenes with high purity characterized in being obtained by the production process of the invention (19).

The invention (21) is a purification system characterized in having a storage container storing material comprising the alkali metal doped fullerenes and non-doped fullerenes, a means for introducing and discharging solvent in the storage container, a stirrer stirring the material immersed in the solvent, residue separators separating residue from solvent after stirring, and a mass analyzer carrying out the mass analysis of the residue.

The invention (22) is the purification system according to the invention (21) characterized in having a liquid chromatography device that provides the further purification of residue and/or solution.

The invention (23) is the purification system according to the invention (21) or (22) wherein the material comprising the alkali metal doped fullerenes and non-doped fullerenes is sooty residue prepared by a device preparing the alkali metal doped fullerenes by a plasma process or an arc discharge process.

The invention (24) is the production system of alkali metal doped fullerenes characterized in having the device preparing the alkali metal doped fullerenes by a plasma process or an arc discharge process and the purification system of the invention (23).

### EFFECT OF THE INVENTION

The separator of the invention (1) can be utilized for purification of doped fullerenes. The doped fullerenes and non-doped fullerenes exist in mixture in the sooty residue purified by a plasma process or an arc discharge process or the like. It can be utilized for purifying the doped fullerenes from the sooty residue.

According to the invention (2), the effect of purification can be improved by using toluene, a mixed solution of toluene and hexane, xylene, anisole, ethylbenzene, trimethylbenzene or cyclohexane that has a large difference in solubility, as the separator.

According to the invention (3), the effect of purification can be improved by using halobenzene, halonaphthalene or a mixed solution of either of them in which the solubility of non-doped fullerenes is large, as the separator.

According to the invention (4), alkali metal that doesn't react with the fullerenes in preparation and compounds thereof can be removed from the aforementioned material such as the sooty residue. Further, they can be removed by a simple and safe method without modifying non-doped fullerenes and doped fullerenes. Possibility of provoking side reaction in further purification step and the like by liquid chromatography thereafter is lowered by removing the alkali metal and compounds thereof that have high reactive property. Therefore, the doped fullerenes can be efficiently purified.

According to the invention (5), lithium salt and the like that are prepared at exposing the aforementioned material in air can be also removed. When the sooty residue prepared, for example, by a plasma method or an arc discharge method is exposed to air, lithium that doesn't react with the fullerenes reacts with moisture, oxygen, and carbon dioxide in air. Then, lithium salts such as lithium carbonate Li₂CO₃ are formed on the surface of the sooty residue. Lithium carbonate Li₂CO₃ and the like are removed by treating this with aqueous solvent such as pure water or the diluted solution of alcohol in argon atmosphere.

The effect of the invention (6) is similar to that of the invention (4).

According to the invention (7), non-doped fullerenes with high solubility are dissolved in the separators by immersing the material in the separators to be treated, and removed from the residue.

According to the invention (8), the effect of purification can be improved by using toluene, a mixed solution of toluene and hexane, xylene, anisole, ethylbenzene, trimethylbenzene or cyclohexane that has a large difference in solubility, as the separators. Further, purification using the separators can be easily carried out at normal temperature and normal pressure.

According to the invention (9), the effect of purification can be improved by using halobenzene, halonaphthalene or a mixed solution of either of them in which the solubility of non-doped fullerenes is large, as the separators. In particular, purification can be easily carried out at normal temperature and normal pressure by using chlorobenzene C₆H₆₋ₓClₓ (x=1 to 3) or a mixed solution thereof.

According to the invention (10), since non-doped fullerenes with high solubility are removed by repeating the treatment at a plurality of times, the content rate of alkali metal doped fullerenes in the residue can be heightened.

According to the invention (11), low molecular carbon compounds that are prepared by destruction of fullerenes being raw materials can be removed from residue during the preparation of the sooty residue or at a purification step thereafter. The treatment can be easily carried out at normal temperature and normal pressure.

According to the invention (12), the content rate of the alkali metal doped fullerenes in the residue can be further heightened. Namely, low molecular carbon compounds that are prepared by destruction of unstable carbon compounds at the step of treatment by separators are removed at the step of treatment with paraffin hydrocarbon or cycloparaffin hydrocarbon.

According to the invention (13), a step of treatment by aqueous solvent is also incorporated for the respective steps of the inventions (7) to (12). Namely, since alkali metal that doesn't react with fullerenes during preparation of the sooty residue and compounds thereof are removed, the content rate of the alkali metal doped fullerenes in the residue can be heightened.

According to the invention (14), alkali metal with high reactivity and compounds thereof are firstly removed. Namely, possibility of provoking side reaction at purification step thereafter is lowered and the alkali metal doped fullerenes can be efficiently purified.

According to the invention (15), alkali metal with high reactivity and compounds thereof and low molecular carbon compounds are removed. Namely, possibility of provoking side reaction at purification step thereafter is further lowered and they can be efficiently purified. Further, when respective steps are repeatedly carried out in such manners as those in the inventions (10) and (12), the target content rate of the alkali metal doped fullerenes in the residue can be attained at little repeating times.

According to the invention (16), the alkali metal doped fullerenes can be purified in high purity by being provided for a further purification step by liquid chromatography. Further, solution containing the doped fullerenes may be provided for the same purification step, and in this case, it exhibits further effect that the amount of the doped fullerenes that are discarded in vain without purification can be reduced.

The effect of the invention (17) is similar to that of the invention (5).

According to the invention (18), the sooty residue in which the alkali metal doped fullerenes are surely contained can be prepared. The alkali metal doped fullerenes with high purity having a residue quantity ratio (molar ratio) of 95% or more can be obtained by purifying the sooty residue by a method containing a further purification step, in particular, by the liquid chromatography of the invention (16).

The invention (20) is alkali metal doped fullerenes with high purity having a residue quantity ratio of 95% or more that are obtained by purification by the step of treatment, in particular, by the separators such as halobenzene or halonaphthalene of the invention (9), or by a method containing a further purification step by the liquid chromatography of the invention (16).

The alkali metal doped fullerenes can be obtained in high purity by using the purification system of the invention (21).

The alkali metal doped fullerenes having a residue quantity ratio of 95% or more can be obtained by using the purification system of the invention (22).

According to the invention (23), the sooty residue in which the alkali metal doped fullerenes are surely contained can be prepared. The alkali metal doped fullerenes with high purity having a residue quantity ratio of 95% or more can be obtained by purifying the sooty residue, in particular, by a purification system containing the liquid chromatography of the invention (22). The alkali metal doped fullerenes can be obtained in high purity by using the production system of the invention (24). In particular, the alkali metal doped fullerenes with high purity having a residue quantity ratio of 95% or more can be obtained by using the purification system containing the liquid chromatography device of the invention (22).

### BRIEF DESCRIPTION OF DRAWINGS

FIG. 1 is a flow chart showing the step of treatment by separators according to the invention.

FIG. 2 is a graph obtained by conducting the treatment of removing lithium metal and compounds thereof and low molecular carbon compounds for the sooty residue that is collected from the depositional substrates of a device for preparing the alkali metal doped fullerenes and carrying out mass analysis.

FIG. 3 is a graph obtained by further immersing the sooty residue treated for the mass analysis of FIG. 2 in toluene, carrying out super sonic stirring and centrifugal separation, and then, conducting mass analysis.

FIG. 4 is a graph obtained by conducting the treatment of removing lithium metal and compounds thereof and low molecular carbon compounds for the sooty residue that is collected from the depositional substrates, then immersing it in toluene and o-dichlorobenzene, carrying out super sonic stirring and centrifugal separation, and conducting mass analysis.

FIG. 5 is a schematic diagram of a device for preparing alkali metal doped fullerenes by a plasma process.

### EXPLANATIONS OF LETTERS OF NUMERALS

601: Vacuum container
602: Introduction inlet of alkali metal
603: Hot plate
604: Electromagnetic coil
605: Plasma flow
606: Tube
607: Depositional substrate
608: Voltage source
609: Fullerene oven

### BEST MODE FOR CARRYING OUT THE INVENTION

The meaning of respective terms related to the invention is clarified below and the best mode of the invention is illustrated.

“Alkali metal” is Element Group situated at the most left side of the Periodical Table and lithium Li, sodium Na, potassium K, rubidium Rb and cesium Cs.

The “fullerenes” are the generic designation of non-doped fullerene surrounded by carbon atoms such as Cₙ (n=60, 70, 76, 78, - - - ), heterofullerene in which the portion of the carbon atoms of said fullerene is substituted with other atom, chemically modified fullerene in which a compound is attached at the portion of the carbon atoms of said fullerene, and the repeating bonded article of mutual fullerenes.

The “alkali metal doped fullerenes” are fullerenes in which one or more of alkali metal atoms such as lithium, sodium and potassium is doped at the hollow portion of fullerenes that are surrounded by carbon atoms and the like.

The “separators” are solvent used for separating the alkali metal doped fullerenes and non-doped fullerenes. Uses are not limited for separation. The “separators” according to the invention are used as detergents. Namely, a solid material containing the alkali metal doped fullerenes and non-doped fullerenes is immersed in the solvent of the separators and stirring, heating and the like are carried out. At this time, dissolved article such as non-doped fullerenes is dissolved in detergents and the content rate of the metal doped fullerenes in the solid material can be enhanced.

The “step of treatment by separators” is a step that is carried out for removing non-doped fullerenes from material containing the alkali metal doped fullerenes and non-doped fullerenes or from residue obtained at purification step thereafter, and enhancing the content rate of the alkali metal doped fullerenes. As the “step of treatment” mentioned here, for example, there can be mentioned a step of immersing the material or the residue in the solvent of separators, stirring or heating it to be mixed and collecting undissolved residue. Both of stirring and heating may be used in combination. As a method of collecting the undissolved residue, centrifugal separation, filtration by a membrane filter or both may be used in combination.

The “halobenzene” is an organic compound in which one or more of hydrogen atoms of benzene C₆H₆ is substituted with halogen atoms such as fluorine and chlorine. The solubility of non-doped fullerenes is large by 5 to 10-fold in comparison with toluene. As the separators at normal temperature and normal pressure, chlorobenzene C₆H₆₋ₓClₓ (x=1 to 3) or a mixed solvent of chlorobenzene and toluene, etc. can be used.

The “halonaphthalene” is an organic compound in which one or more of hydrogen atoms of naphthalene C₁₀H₈ is substituted with halogen atoms such as fluorine and chlorine. The solubility of non-doped fullerenes is large by 5 to 10-fold in comparison with toluene.

The “sooty residue” is solid material prepared by a plasma process or an arc discharge process or the like using the alkali metal and fullerenes. The alkali metal doped fullerenes and non-doped fullerenes are contained in the sooty residue and the sooty residue is one of “materials containing the alkali metal doped fullerenes and non-doped fullerenes”.

The “step of treatment by aqueous solvent” is a step that is carried out for removing the alkali metal that doesn't react with fullerenes in preparation of the alkali metal doped fullerenes and compounds thereof, from the sooty residue that was prepared by, for example, a plasma process or an arc discharge process or the like. As the “aqueous solvent”, solution such as tap water, pure water, water and acid or alcohol diluted with water can be used. As the “step of treatment” mentioned here, for example, there can be mentioned a step of immersing the sooty residue in aqueous solvent, stirring or heating it to be mixed and then collecting undissolved residue. Both of stirring and heating may be used in combination. As a method of collecting the undissolved residue, centrifugal separation, filtration by a membrane filter or both may be used in combination.

The “pure water” is water in which electric conductivity is 1 μS/cm or less and electrolyte is almost removed. It includes ion-exchange water, deionized water and the like. When the non-doped fullerenes are used as doping material, pure water with high purity is required. In this case, it is preferable to treat with pure water. In particular, it is preferable to treat with ultra pure water having an electric conductivity of 0.06 μS/cm or less.

Further, the treatment may be carried out at multi stages in such a manner that after treatment with the dilution solution of acids such as hydrochloric acid and sulfuric acid at “step of treatment by aqueous solvent”, treatment is carried out with pure water. When the sooty residue is treated by immersion into the dilution solution of acid, the alkali metal that doesn't react with fullerenes becomes hydroxide and neutral salt, is dissolved in diluted solution and is removed from the sooty residue. Then, acid adhering on the sooty residue is also removed by treatment with pure water.

The “low molecular carbon compound” is the decomposed product of fullerenes that are prepared during the preparation of the sooty residue by a plasma process or an arc discharge process or the like or at the purification step thereafter (for example, a step of treating with aqueous solvent), and a reaction product that is prepared by the decomposed product's reaction with other elements, etc.

The “step of treatment with paraffin hydrocarbon or cycloparaffin hydrocarbon” is a step that is carried out for removing the aforementioned low molecular carbon compound during the preparation of the alkali metal doped fullerenes or at the purification step thereafter. The “paraffin hydrocarbon” is saturated linear hydrocarbon represented by the chemical formula CₙH₂ₙ₊₂. The “cycloparaffin hydrocarbon” is hydrocarbon represented by the chemical formula CₙH₂ₙ in which a methylene group —CH₂— constitutes one ring. Although the fullerenes are hardly dissolved in these solvents, the low molecular carbon compound is dissolved well. As the “step of treatment” mentioned here, for example, there can be mentioned a step of immersing the sooty residue or the residue obtained at the purification step thereafter in the solvent of paraffin hydrocarbon or cycloparaffin hydrocarbon, stirring or heating it to be mixed and collecting the undissolved residue. At this time, the low molecular carbon compound is dissolved and removed from the sooty residue. Both of stirring and heating may be used in combination. As a method of collecting the undissolved residue, centrifugal separation, filtration by a filter or both may be used in combination.

The “inactive atmosphere” is space satisfied with inactive gases such as argon and helium. For example, when lithium is used as the alkali metal, lithium carbonate Li₂CO₃ and the like are formed on the surface of the sooty residue when the sooty residue prepared by a plasma process or an arc discharge process is exposed to air. This can be removed by treating this with aqueous solvent such as the diluted solution of pure water or alcohol.

The “alkali metal doped fullerenes with high purity” is alkali metal doped fullerenes having a residue quantity ratio (molar ratio) of 95% or more. Mass analysis is carried out, for example, LD ToF-Mass (time-of-flight mass separating device by laser desorption ionization). At this time, the doped fullerenes and non-doped fullerenes forming dimer and trimer are ionized to be isolated and measured as monomers. It is the alkali metal doped fullerenes with high purity in which the proportion of detection intensity of the doped fullerenes measured as monomers is 95% or more.

(Preparation of Alkali Metal Doped Fullerenes)

FIG. 5 shows the schematic diagram of a device preparing the alkali metal doped fullerenes by a plasma process.

After the atmosphere of a vacuum container 601 was sucked in vacuum, alkali metal is injected from the introduction inlet 602 of alkali metal. When the injected alkali metal collides with a hot plate 603 that is heated, it is ionized by contact to generate plasma. The vacuum degree of the vacuum container 601 is preferably 10⁻⁴ to 10⁻⁵ Torr. When plasma is generated from lithium atom, the hot plate 603 is preferably heated at 2700° C. or more.

Homogeneous magnetic field (2 to 7 kG) is formed by an electromagnetic coil 604 arranged at the outside of the vacuum container 601. Plasma flow 605 is formed by confining the plasma generated to an axial direction in the vacuum container 601 along the homogeneous magnetic field. The diameter of the hot plate 603 is nearly the diameter of the plasma flow 605.

Fullerenes are introduced in the plasma flow 605 from a fullerene oven 609 through a copper tube 606. The tube 606 is preferably heated at 400 to 650° C. Relation between distance ld from the edge at downstream side to a depositional substrate 607 and the length lc of the tube is preferably ld≧2lc. Further, the inner diameter of the tube 606 is preferably 2.5 to 3.0-fold of the diameter of the plasma flow 605.

A cooling means (not illustrated) is provided at the outer periphery of the vacuum container 601, and it is preferable that the inner wall of the vacuum container 601 from the edge at downstream side of the tube 606 to the depositional substrate 607 is cooled to room temperature or less. 0° C. or less is preferable in particular. Neutral molecule is easily trapped in the inner wall of the vacuum container 601 by the constitution and the alkali metal doped fullerenes with high purity can be obtained.

When the alkali metal is doped in fullerene C₆₀, bias voltage of −5 to +20V is preferably applied from a voltage source 608 to the depositional substrate 607. Bias voltage of 0 to 18V is preferable. At this time, interaction between alkali atom ion and fullerene ion is enlarged and the alkali metal atom is easily doped.

The alkali metal doped fullerenes can be also prepared by an arc discharge process. Graphite is deposited on, for example, an electrode in the arc discharge process. Voltage is supplied to the electrode to carry our arc discharge and the alkali metal is sprayed between electrodes. At this time, graphite deposited on the electrode is evaporated to prepare fullerenes and partially prepare the alkali metal doped fullerenes. The sooty residue containing these non-doped fullerenes and alkali metal doped fullerenes is deposited on the electrode and the like.

Non doped fullerenes, alkali metal that doesn't react with fullerenes during preparation of the sooty residue, further, low molecular carbon compound prepared by decomposition of fullerene and the like in addition to the alkali metal doped fullerenes are contained in the sooty residue prepared by a plasma process or an arc discharge process or the like. The alkali metal and compounds thereof, non-doped fullerenes and low molecular carbon compound are required to be removed in advance of treatment by liquid chromatography, in order to purify the alkali metal doped fullerenes in high purity from the sooty residue. The respective steps described below are carried out for its purpose.

(Step of Treatment by Aqueous Solvent)

After the sooty residue is collected from a depositional substrate, electrode and the like, the alkali metal that doesn't react with fullerenes during preparation of the sooty residue and compounds thereof (example: alkali metal salts, compounds prepared by electrically bonding the alkali metal atoms at the outside of hollow fullerenes, lithium carbonate Li₂CO₃ and the like) are removed from the sooty residue by treating it with aqueous solvent.

For example, it is immersed in tap water and mixed by stirring. The alkali metal that doesn't react with fullerenes during preparation of the sooty residue and compounds thereof provoke chemical reaction with water, are converted to hydroxides and the like to be dissolved and are removed from the sooty residue. In place of stirring, it may be mixed by heating. Alternatively, both of mixing and heating may be used in combination.

Then, centrifugal separation or filtration by a membrane filter is conducted. Both may be used in such a manner that the filtration by a membrane filter is conducted after the centrifugal separation. The centrifugal separation is preferably carried out at a rotational number of 2000 cycles or more per one minute (for example, 2500 cycles/min for about 30 minutes). Insoluble articles precipitated after the centrifugal separation are taken out and obtained as residue. Further, when the filtration is carried out, the insoluble articles remaining in a filter are also obtained as the residue.

As an alternative means, mode that they are immersed in acidic solution, stirred and/or heated can be mentioned. The alkali metal that doesn't react with fullerenes during preparation of the sooty residue and compounds thereof are converted to hydroxides and neutral salts to be dissolved and are removed from the sooty residue. When safety for use at a mass production step must be considered, acidic diluted solution is preferably used. The acquisition method of the residue is same as that of stirring with water.

(Step of Treatment by Separators)

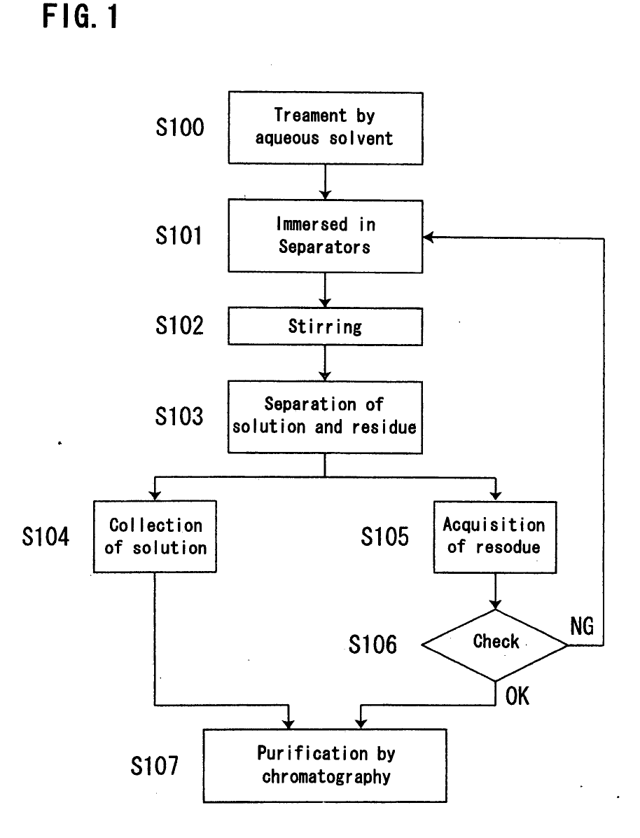

FIG. 1 shows the flow chart of the step of treatment by separators. The step is a step that is carried out for removing non-doped fullerenes from the sooty residue or the residue obtained at purification step thereafter, and enhancing the content rate of the alkali metal doped fullerenes.

The alkali metal and compounds thereof are removed at the step of treating the sooty residue prepared by a plasma process or an arc discharge process or the like with aqueous solvent (S100). The residue from which the alkali metal and compounds thereof are removed is immersed in the separators (S101). As the separators, for example, toluene, a mixed solution of toluene and hexane, xylene, anisole, ethylbenzene, trimethylbenzene, cyclohexane or chlorobenzene C₆H₆₋ₓClₓ (x=1 to 3) or the like is used, temperature is kept at a range of room temperature to 40° C. and mixing is conducted by stirring (S102). The stirring may be carried out by ultrasonic stirring or magnetic stirring. In place of stirring, they may be mixed by heating. Alternatively, both of mixing and heating may be used in combination.

Then, centrifugal separation or filtration by a membrane filter is conducted and solution and insoluble articles are separated (S103). Both may be used in such a manner that the filtration by a membrane filter is conducted after the centrifugal separation. The centrifugal separation is preferably carried out at a rotational number of 2000 cycles or more per one minute.

Insoluble articles precipitated after the centrifugal separation are taken out and obtained as residue (S105). When the filtration is carried out, the insoluble articles remaining in a filter are also obtained as the residue. Further, when the alkali metal doped fullerenes are also purified from the solution separated at the step of purification by liquid chromatography, the solution is collected (S104).

Then, it is checked whether operation is transferred to the step of purification by liquid chromatography or not (S106). For example, it is checked whether the residue quantity (molar number) of the alkali metal doped fullerenes contained in the residue is 10-fold or more of the residue quantity of non-doped fullerenes or not. The mass analysis of the residue is conducted in order to do so and it is checked whether the detection intensity of the alkali metal doped fullerenes is 10-fold or more of the detection intensity of the non-doped fullerenes or not. When it is not 10-fold or more, operation returns to the step S101. Then, the residue is immersed in the separators and stirring, centrifugal separation and the like are repeated.

When the detection intensity of the alkali metal doped fullerenes in the residue is about 10-fold or more in comparison with the non-doped fullerenes, the step of treatment by separators is terminated and operation is transferred to purification (S107) by chromatography that is the next step. Namely, the residue is dissolved in a solvent having high solubility of the alkali metal doped fullerenes, for example, aniline and the like, and liquid chromatography is applied to it. The content rate of the alkali metal doped fullerenes can be improved to 95% or more by applying liquid chromatography.

Further, the alkali metal doped fullerenes exist also in the solution. The alkali metal doped fullerenes can be purified by applying the solution to liquid chromatography as it is.

Other method by which the residue quantity ratio (molar ratio) of the non-doped fullerenes to the alkali metal doped fullerenes is determined by measurement of visible ultraviolet absorption spectrum, and the like may be used for the check of the step S106.

It is preferable that the step of treatment by aqueous solvent is performed before the step of treatment by separators, and alkali metal and compounds thereof are removed from the sooty residue prepared by a plasma process or an arc discharge process or the like. Namely, since the alkali metal having high reactivity is removed, the later step of treatment by separators, the step of treatment by paraffin hydrocarbon or cycloparaffin hydrocarbon and the like can be stably carried out. Further, the content rate of the alkali metal doped fullerenes in the residue can be enhanced by little repeating cycles, for example, 1 to 3 times.

Halobenzene and halonaphthalene have high solubility of non-doped fullerenes. For example, it is about 5 to 10-fold in comparison with toluene. The content rate of the alkali metal doped fullerenes in the residue can be enhanced by little repeating cycles, by using halobenzene and halonaphthalene as the separators.

Further, the separators are not limited to one kind. For example, treatment by toluene and dichlorobenzene may be repeated. At this time, even if further purification step by liquid chromatography is not carried out, the alkali metal doped fullerenes with high purity having a residue quantity ratio of 95% or more are occasionally obtained.

(Step of Treatment by Paraffin Hydrocarbon or Cycloparaffin Hydrocarbon)

The decomposed product of fullerenes and reaction product prepared by reaction of the decomposed product with other elements exist in the sooty residue prepared by a plasma process or an arc discharge process or the like. Further, there are also those generated at the step of treatment by aqueous solvent thereafter and the step of treatment by the separators. These low molecular carbon compounds are preferably removed for obtaining the alkali metal doped fullerenes with high purity. The sooty residue or residue through the purification step thereafter are immersed in the solvents of paraffin hydrocarbon or cycloparaffin hydrocarbon and mixed by stirring. At this time, the low molecular carbon compounds are dissolved in paraffin hydrocarbon or cycloparaffin hydrocarbon and removed from the sooty residue. In place of stirring, they may be mixed by heating. Alternatively, both of mixing and heating may be used in combination.

The residue is collected by carrying out centrifugal separation or filtration by a membrane filter in such a manner as the step of treatment by aqueous solvent and the step of treatment by the separators. After centrifugal separation, filtration by a membrane filter or both may be used in combination.

As the paraffin hydrocarbon, hexane C₆H₁₄, heptane C₇H₁₆, octane C₈H₁₈ and the like may be used. As the cyclohexane hydrocarbon, cyclohexane C₆H₁₂, cycloheptane C₇H₁₄, cyclooctane C₈H₁₆ and the like may be used.

The step of treatment by paraffin hydrocarbon or cycloparaffin hydrocarbon is preferably repeated a plurality of times in such a manner as the step of treatment by the separators. Unstable carbon compounds in which the portion of fullerenes is degraded are also prepared during the preparation of the sooty residue prepared based on a plasma process or an arc discharge process or the like. These unstable carbon compounds are decomposed at the step of treatment by aqueous solvent or the step of treatment by the separators and become low molecular carbon compounds. The content rate of the alkali metal doped fullerenes in the residue can be enhanced by repeatedly carrying out the step of treatment by paraffin hydrocarbon or cycloparaffin hydrocarbon that removes the low molecular carbon compounds and the step of treatment by the separators.

(Treatment in Inactive Atmosphere)

For example, the sooty residue is prepared by a plasma process or an arc discharge process, using lithium as the alkali metal. When the sooty residue is exposed to air, lithium that doesn't react with fullerenes reacts with moisture, oxygen and carbon dioxide in air and lithium carbonate Li₂CO₃ is formed on its surface. This can be removed by treating it by aqueous solvent such as diluted solution such as pure water or alcohol in inactive atmosphere such as argon or helium. The method of treatment by the aqueous solvent is mentioned above.

Alternatively, when the sooty residue is transferred from the preparation apparatus to the step of treatment by aqueous solvent, the step of treatment by the separators and the like and other some processes may be also carried out in inactive atmosphere.

Since the separators, aqueous solvent and the like that can be treated at normal pressure are used in the present invention, the pressure of inactive atmosphere is not specifically limited.

(Purification System of Alkali Metal Doped Fullerenes)

The system purifying the alkali metal doped fullerenes can be constituted using an existing apparatus. For example, it is constituted by a storage container storing the sooty residue, a syringe as a means for introducing and discharging aqueous solvent, the separators and the like into said storage container, a stirring device, a centrifugal separation device, a mass analyzer and a liquid chromatography device and purifies it in accordance with the flow chart shown in FIG. 1.

The sooty residue prepared by a plasma process or an arc discharge process or the like is charged in the storage container and the step of treatment by the aqueous solvent is carried out. The aqueous solvent is introduced in the storage container at this step, using a syringe. After the storage container is installed on the stirring device to be stirred, and installed on a centrifugal separation device to carry out centrifugal separation. Components not soluble in the aqueous solvent in the sooty residue are precipitated and deposited on the bottom of the storage container. Then, the solvent is discharged from the storage container using the syringe and transferred to the next step of treatment by the separators.

After the separators are charged in the storage container and treated by a method similar to the aforementioned description, the residue deposited on the bottom of the storage container is dried. Then, the physical quantity (molar number) of the alkali metal doped fullerenes contained in the residue is checked using a mass analyzer. When the physical quantity is not 10-fold or more of the physical quantity of non-doped fullerenes, treatment by the separators is repeated.

When it is 10-fold or more, the step of treatment by the separators is terminated. Then, the alkali metal doped fullerenes with high purity is purified by purification using liquid chromatography device.

The low molecular carbon compounds may be removed by incorporating the step of treatment by paraffin hydrocarbon or cycloparaffin hydrocarbon at the step of treatment by the aqueous solvent and the step of treatment by the separators. After paraffin hydrocarbon or cycloparaffin hydrocarbon is introduced in the storage container at the step, the same treatment as the aforementioned two steps is carried out.

All processes including respective steps and movement between steps or some processes may be carried out in inactive atmosphere.

A control device is added additionally to the present system and the aforementioned serial treatments may be automatically carried out.

(Production System of Alkali Metal Doped Fullerenes)

The production system of the alkali metal doped fullerenes is constituted by adding the preparation apparatus of the alkali metal doped fullerenes to the purification system of the alkali metal doped fullerenes. As the preparation system of the alkali metal doped fullerenes, the apparatus by a plasma process shown in FIG. 5 or an apparatus by an arc discharge process or other process can be used.

Further, serial treatments may be automatically carried out by adding a control device to the present system.

### EXAMPLES

### Example 1

### Preparation of Lithium Atom Doped Fullerene

The sooty residue containing lithium atom doped fullerene was prepared by a plasma process using a device shown in FIG. 5.

The diameter of the hot plate 603 was 20 mm. The diameter of plasma flow generated by collision of lithium metal with the hot plate is nearly same as it. The inner diameter of the tube 606 was 55 mm. Further, the length lc of the tube was 200 mm and distance ld from the downstream side edge of the tube 606 to the depositional substrate 607 was 450 mm. Magnetic field of 3 kG was applied from the magnetic field coil 604. The temperature of the hot plate 603 was 2900° C., the temperature of the tube 606 was 550° C., the temperature of the inner wall of the vacuum container 601 from the downstream side edge of the tube 606 to the depositional substrate 607 was set at 0° C. The degree of vacuum of the vacuum container 601 was set at 2×10⁻⁵ Torr. Voltage of 5V was supplied to the depositional substrate 607 from the voltage source 608. Then, lithium was introduced by 6 mg/hr from the alkali metal introducing inlet 602 and fullerene C₆₀ was introduced by 80 mg/hr from the fullerene oven 609 to prepare lithium atom doped fullerene.

(Removal of Lithium Metal and Compound Thereof)

About 500 mg of the sooty residue was collected from the depositional substrate 607, 100 mg of distilled water was charged thereto and stirring was carried out at room temperature for 60 minutes. Then, after centrifugal separation at a rotational number of 2500 cycles per one minute was carried out for 30 minutes, and precipitate was taken out and collected as residue. Further, after supernatant liquid was filtrated with a membrane filter (pore diameter of 0.45 μm), article remaining on the filter was also collected as the residue and it was joined with the aforementioned residue.

(Separation of Lithium Atom Doped Fullerene by Toluene)

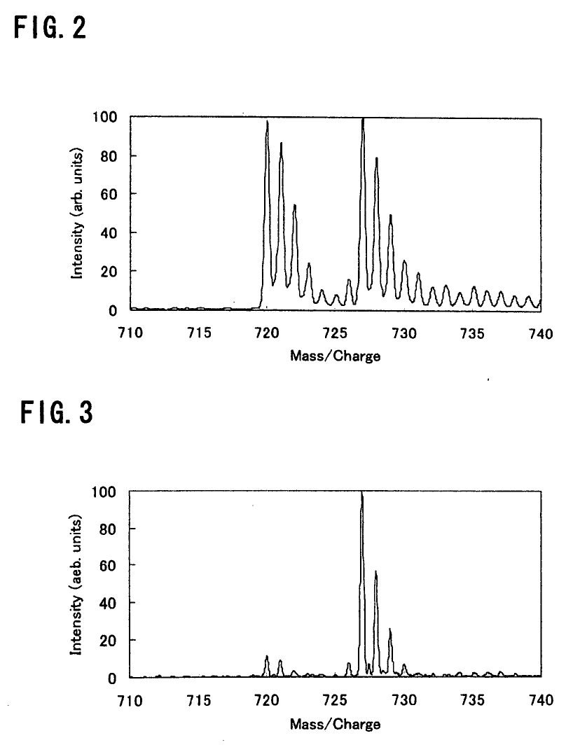

Low molecular carbon compounds were removed by immersing the residue in 100 mg of hexane C₆H₁₄ and stirring by ultrasonic wave for 60 minutes. Then, mass analysis was carried out. The mass analysis was carried out by setting positive ion and linear mode, using a time-of-flight type mass analyzer (Shimadzu/KRATOS AXIMA-CFR plus) manufactured by Shimadzu Corporation. The result of mass analysis is shown in the graph of FIG. 2.

The residue treated for the mass analysis of FIG. 2 was immersed in 100 mg of toluene and ultrasonic stirring and centrifugal separation was repeated 5 times. The ultrasonic stirring was carried out at room temperature for 2 hours and the centrifugal separation was carried out at a rotational number of 2500 cycles per one minute for 30 minutes. After the centrifugal separation, the residue excluding the supernatant liquid was immersed in toluene and the ultrasonic stirring was repeated. After the operation was repeated 5 times, a graph of mass analysis is shown in FIG. 3.

The horizontal axis is mass number and the longitudinal axis is detection intensity for both graphs. For the sooty residue collected from the depositional substrate, the detection intensity of non-doped fullerenes C₆₀ (mass number of 720) and that of the lithium atom doped fullerene Li@C₆₀ (mass number of 727) were nearly same. However, by repeating the operation at 5 times, the detection intensity ratio of the lithium atom doped fullerene was about 10-fold in comparison with the non-doped fullerene and the non-doped fullerene could be reduced. Further, as a result of mass analysis of the solution, only the non-doped fullerene was detected and the lithium atom doped fullerene was not detected.

The residue used for the mass analysis of FIG. 3 was applied to liquid chromatography. At that time, 10 mg of the residue was dissolved in 20 mg of o-dichlorobenzene and charged in a Buckyprep-M column (10 mmφ×250 mm) manufactured by Nakarai Tesk Co., Ltd. Then, flow rate was set at 5 ml/min. Further, it was detected with an ultraviolet absorption detector (wavelength of 330 nm). Those eluted between 16 minutes to 23 minutes by the ultraviolet absorption detector were collected and as a result of mass analysis, the lithium atom doped fullerene with high purity having residue quantity ratio (molar ratio) of 95% was obtained.

### Example 2

### Separation of Lithium Atom Doped Fullerene by Anisole

Treatment for removing lithium metal that doesn't react with fullerene during plasma discharge and compounds thereof and low molecular carbon compounds prepared by decomposition of fullerene from 500 mg of the sooty residue collected from the depositional substrate of a plasma device was carried out by the same technique as the procedure of Example 1. The residue was immersed in 100 mg of anisole as the separators of the lithium atom doped fullerene, and ultrasonic stirring and centrifugal separation was repeated 5 times. The ultrasonic stirring and the centrifugal separation were carried out by the same procedure as Example 1. Further, as the result of mass analysis, the detection intensity ratio of the non-doped fullerenes to the lithium atom doped fullerene was about 3 to 10. Consequently, it is deduced that the lithium atom doped fullerene is contained in the residue at a residue quantity ratio of 100.0×10/(3+10)=77%. Further, the detection intensity ratio of both molecules in the solution was about 2 to 1.

### Example 3

### Separation of Lithium Atom Doped Fullerene by Mixed Solution of Toluene and Hexane

Treatment for removing lithium metal that doesn't react with fullerene during plasma discharge and compounds thereof and low molecular carbon compounds prepared by decomposition of fullerene from 500 mg of the sooty residue collected from the depositional substrate of a plasma device was carried out by the same technique as the procedure of Example 1. Solution in which the mixing rate of toluene to hexane was 1 to 1 was used as the separator of the lithium atom doped fullerene. The residue was immersed in 100 mg of the mixed solution by the same technique as the procedure of Example 1, and ultrasonic stirring and centrifugal separation was repeated 5 times. At this time, only the non-doped fullerene was dissolved in the separator. However, as the result of mass analysis, the detection intensity ratio of the non-doped fullerene to the lithium atom doped fullerene in the residue was about 6 to 10. Namely, the content rate of the lithium atom doped fullerene is 100.0×10/(6+10)=63% by a residue quantity ratio.

### Example 4

### Separation of Lithium Atom Doped Fullerene by Toluene and o-dichlorobenzene

Treatment for removing lithium metal that doesn't react with fullerene during plasma discharge and compounds thereof and low molecular carbon compounds prepared by decomposition of fullerene from 500 mg of the sooty residue collected from the depositional substrate of a plasma device was carried out by the same technique as the procedure of Example 1. The residue was immersed in 100 mg of toluene, and ultrasonic stirring and centrifugal separation was repeated twice. Further, the residue was immersed in 100 mg of o-dichlorobenzene, and ultrasonic stirring and centrifugal separation was repeated 3 times.

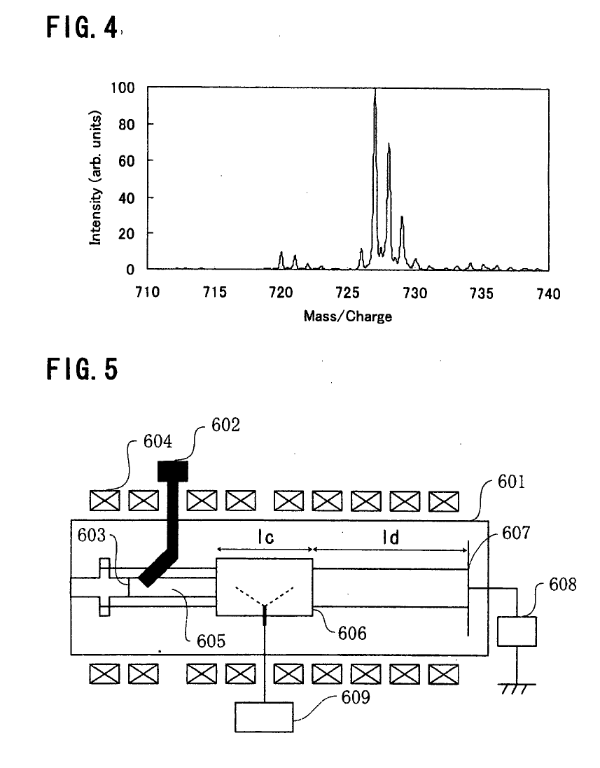

Then, the mass analysis of the residue was carried out. Its graph is shown in FIG. 4. The detection intensity ratio of the lithium atom doped fullerene was about 10-fold in comparison with the non-doped fullerene. The lithium atom doped fullerene with high purity having a residue quantity ratio of 95% or more was obtained without further purification step by liquid chromatography.

### Example 5

### Purification of Lithium Atom Doped Fullerene Omitting 2 Steps

After 500 mg of the sooty residue was collected from the plasma device, purification was tried omitting the step of treatment by aqueous solvent or the step of treatment by paraffin hydrocarbon or cycloparaffin hydrocarbon.

The step of treatment by aqueous solvent was omitted, the sooty residue was immersed in hexane, ultrasonic stirring was carried out, then it was immersed in toluene and the ultrasonic stirring was carried out 5 times. As the result of mass analysis, there are observed many peaks other than mass numbers of 720 and 727 corresponding to non-doped fullerenes C₆₀ and the lithium atom doped fullerene Li@C₆₀. It is considered that side reaction occurs by alkali metal remaining and compounds thereof and materials prepared by the side reaction remains.

When only the step of treatment by paraffin hydrocarbon or cycloparaffin hydrocarbon is omitted, no peak other than nearby mass numbers of 720 and 727 was observed. When toluene is used as the separator, it is considered that the low molecular carbon compounds are also dissolved to be removed.

### INDUSTRIAL APPLICABILITY

As described above, the present invention is technology enabling the high purity of the alkali metal doped fullerenes and application to fields such as electronics and medical care is expected.

1-3. (canceled)

4. A method for removing alkali metal and compounds thereof from the fullerenes comprising a step of treating with aqueous solvent or acidic solution.

5. (canceled)

6. A purification process for alkali metal doped fullerenes comprising a step of treating material containing alkali metal doped fullerenes and non-doped fullerenes by aqueous solvent or acidic solution.

7-24. (canceled)

25. A process for producing a composition comprising alkali metal doped fullerenes, characterized in having a step of removing non-doped fullerenes by which the non-doped fullerenes is preferentially dissolved to be removed using a solvent in which the solubility of fullerenes not doping alkali metal (non-doped fullerenes) is higher than that of a composition comprising the alkali metal doped fullerenes.

26. The process for producing a composition comprising alkali metal doped fullerenes according to claim 25, wherein the alkali metal is Li, Na or K.

27. The process for producing a composition comprising alkali metal doped fullerenes according to claim 26, wherein the organic solvent is toluene, a mixed solution of toluene and hexane, xylene, anisole, ethylbenzene, trimethylbenzene or cyclohexane.

28. The process for producing a composition comprising alkali metal doped fullerenes according to claim 26, wherein the organic solvent is halobenzene, halonaphthalene or a mixed solution containing halobenzene or halonaphthalene.

29. The process for producing a composition comprising alkali metal doped fullerenes according to claim 25, wherein the step of treatment by aqueous solvent or acidic solution is carried out as the anterior step of a step of removing the non-doped fullerenes.

30. The process for producing a composition comprising alkali metal doped fullerenes according to claim 25, characterized in having the step of treatment by paraffin solvent by rinsing with the paraffin solvent as the posterior step of a step of removing the non-doped fullerenes.

31. The process for producing a composition comprising alkali metal doped fullerenes according to claim 25, wherein initial material comprises the sooty residue prepared based on a plasma process or an arc discharge process.

32. A composition comprising alkali metal doped fullerenes, wherein solubility for water is lower than the alkali metal, solubility for toluene is lower than C60, and solubility for aniline is higher than solubility for paraffin solvent.

33. The composition comprising alkali metal doped fullerenes according to claim 32, characterized in being the reaction product of chemical species containing alkali metal with non-doped fullerenes.

34. The composition comprising alkali metal doped fullerenes according to claim 33, wherein the reaction product comprises the sooty residue prepared by a plasma process or an arc discharge process.

35. The process for producing a composition comprising alkali metal doped fullerenes according to claim 26, wherein the step of treatment by aqueous solvent or acidic solution is carried out as the anterior step of a step of removing the non-doped fullerenes.

36. The process for producing a composition comprising alkali metal doped fullerenes according to claim 27, wherein the step of treatment by aqueous solvent or acidic solution is carried out as the anterior step of a step of removing the non-doped fullerenes.

37. The process for producing a composition comprising alkali metal doped fullerenes according to claim 28, wherein the step of treatment by aqueous solvent or acidic solution is carried out as the anterior step of a step of removing the non-doped fullerenes.

38. The process for producing a composition comprising alkali metal doped fullerenes according to claim 26, characterized in having the step of treatment by paraffin solvent by rinsing with the paraffin solvent as the posterior step of a step of removing the non-doped fullerenes.

39. The process for producing a composition comprising alkali metal doped fullerenes according to claim 27, characterized in having the step of treatment by paraffin solvent by rinsing with the paraffin solvent as the posterior step of a step of removing the non-doped fullerenes.

40. The process for producing a composition comprising alkali metal doped fullerenes according to claim 28, characterized in having the step of treatment by paraffin solvent by rinsing with the paraffin solvent as the posterior step of a step of removing the non-doped fullerenes.

41. The process for producing a composition comprising alkali metal doped fullerenes according to claim 29, characterized in having the step of treatment by paraffin solvent by rinsing with the paraffin solvent as the posterior step of a step of removing the non-doped fullerenes.

42. The process for producing a composition comprising alkali metal doped fullerenes according to claim 26, wherein initial material comprises the sooty residue prepared based on a plasma process or an arc discharge process.
